(19) United States
(12) Patent Application Publication
(10) Pub. No.: US 2025/0259528 A1
(43) Pub. Date: Aug. 14, 2025

(54) SYSTEM TO ALERT USER OF A FORGOTTEN ITEM

(71) Applicant: Karen Hayhurst, Franklin, NC (US)

(72) Inventor: Karen Hayhurst, Franklin, NC (US)

(21) Appl. No.: 18/440,075

(22) Filed: Feb. 13, 2024

(51) Int. Cl. G08B 21/24; G08B 3/10

(52) U.S. Cl. CPC G08B 21/24; G08B 3/10

(57) ABSTRACT

A transmitter to alert a user of a forgotten item, the transmitter including a transmitter universal serial bus (USB) plug insertable into a USB port within a vehicle to provide power to the transmitter when the vehicle is powered on, a transmitter central processing unit (CPU) electrically connected to the transmitter USB plug to allow the transmitter to BLUETOOTH pair with the forgotten item, and a transmitter speaker electrically connected to the transmitter CPU to emit a sound to alert the user when the forgotten item is out of BLUETOOTH connectivity range with respect to the transmitter, such that the transmitter speaker emits the sound in response to the vehicle being powered on and in response to the forgotten item being out of BLUETOOTH connectivity range with respect to the transmitter.

### BACKGROUND

### 1. Field

The present general inventive concept relates generally to a system, and particularly, to a system to alert a user of a forgotten item.

### 2. Description of the Related Art

In today's fast-paced world, it is easy to overlook grabbing essential devices and items before leaving a place and heading to one's car to drive to a different location.

For example, when a person is in a hurry to get to a place of employment, it is very easy to forget to bring an important item, such as a wallet, purse, cell phone, laptop computer, etc.

Currently, there is nothing in the market that serves to expand the function of an automobile permitting it to alert a user when and if an item is not present within their primary car.

In other words, there is a need for a system that will alert a user if the user forgot an important item at home.

### SUMMARY

The present general inventive concept provides a system to alert a user of a forgotten item.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a transmitter to alert a user of a forgotten item, the transmitter including a transmitter main body, a transmitter universal serial bus (USB) plug connected to the transmitter main body, such that the transmitter USB plug is insertable into a USB port within a vehicle to provide power to the transmitter when the vehicle is powered on, a transmitter central processing unit (CPU) electrically connected to the transmitter USB plug to allow the transmitter to BLUETOOTH pair with the forgotten item, and a transmitter speaker electrically connected to the transmitter CPU to emit a sound to alert the user when the forgotten item is out of BLUETOOTH connectivity range with respect to the transmitter, such that the transmitter speaker emits the sound in response to the vehicle being powered on when the transmitter USB plug is plugged into the USB port within the vehicle and in response to the forgotten item being out of BLUETOOTH connectivity range with respect to the transmitter.

The forgotten item may be a mobile device.

The transmitter main body may further include a transmitter BLUETOOTH pairing button electrically connected to the transmitter CPU to allow the transmitter to BLUETOOTH pair with the forgotten item in response to the transmitter BLUETOOTH pairing button being pressed when the forgotten item is within a BLUETOOTH connectivity range with respect to the transmitter.

The transmitter main body may further include a transmitter speaker suppress button electrically connected to the transmitter CPU to cause the transmitter speaker to stop emitting the sound when the transmitter speaker suppress button is pressed.

The foregoing and/or other features and utilities of the present general inventive concept may also be achieved by providing a system to alert a user of a forgotten item, the system including a receiver device having BLUETOOTH connectivity capabilities, the receiver device including receiver device central processing unit (CPU) to provide the BLUETOOTH connectivity for the receiver device, and a transmitter, including a transmitter main body, a transmitter universal serial bus (USB) plug connected to the transmitter main body, such that the transmitter USB plug is insertable into a USB port within a vehicle to provide power to the transmitter when the vehicle is powered on, a transmitter central processing unit (CPU) electrically connected to the transmitter USB plug to allow the transmitter to BLUETOOTH pair with the receiver device, and a transmitter speaker electrically connected to the transmitter CPU to emit a sound to alert the user when the receiver device is out of BLUETOOTH connectivity range with respect to the transmitter, such that the transmitter speaker emits the sound in response to the vehicle being powered on when the transmitter USB plug is plugged into the USB port within the vehicle and in response to the receiver device being out of BLUETOOTH connectivity range with respect to the transmitter.

The receiver device CPU may be programmable to identify the forgotten item, such that the sound emitted by the transmitter speaker identifies the forgotten item by name.

The forgotten item may be one of a purse, a wallet, a laptop, a grocery bag, and a briefcase, and the sound emitted by the transmitter speaker may be one of spoken phrases of “purse,” “wallet”, “laptop”, “grocery bag,” and “briefcase,” respectively.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates a system to alert a user of a forgotten item including a transmitter with a USB plug in a first position, according to an exemplary embodiment of the present general inventive concept;

FIG. 1B illustrates the system to alert a user of a forgotten item including the transmitter of FIG. 1A with the USB plug in a second position, according to an exemplary embodiment of the present general inventive concept; and

FIG. 2 illustrates a receiver device to connect to the system to alert a user of a forgotten item including the transmitter of FIG. 1A and FIG. 1B, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Mobile Device 10
System To Alert a User of a Forgotten Item 100
Transmitter 101
Transmitter Main Body 110
USB Port Holding Portion 111
Fulcrum Rod 112
Transmitter Central Processing Unit (CPU) 113
Transmitter BLUETOOTH Pairing Button 114
Transmitter Speaker Suppress Button 115
Transmitter Universal Serial Bus (USB) Plug 120
Car Lighter Adapter Plug 130
Transmitter Speaker 140
USB Ports 150
Receiver Device 200
Receiver Device Main Body 210
Receiver Device Central Processing Unit (CPU) 211
Receiver Device BLUETOOTH Pairing and Speaker Suppress Button 212
Receiver Device Clip 213
Receiver Device Universal Serial Bus (USB) Plug 220
Receiver Device Speaker 230

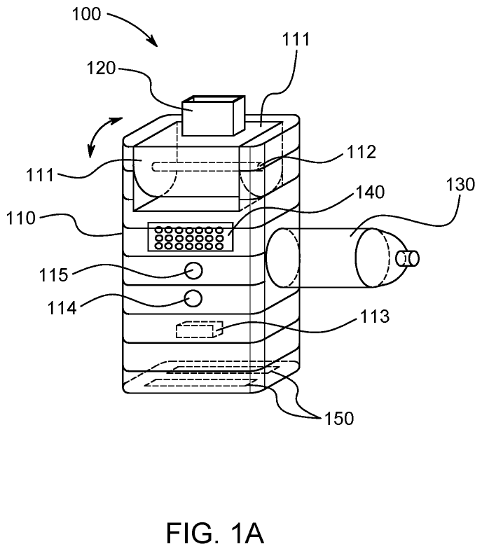

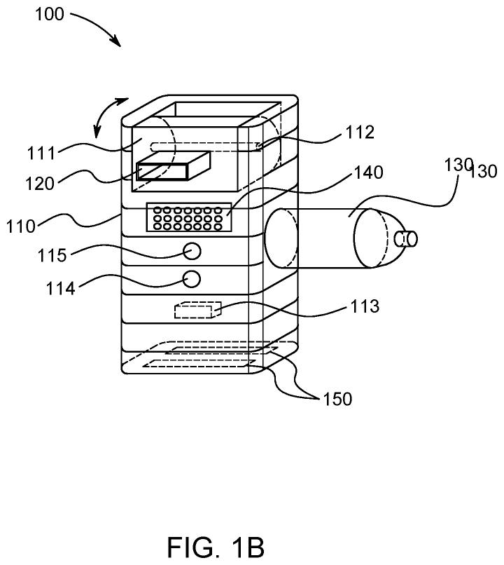

FIG. 1A illustrates a system to alert a user of a forgotten item 100 including a transmitter 101 with a USB plug 120 in a first position, according to an exemplary embodiment of the present general inventive concept.

FIG. 1B illustrates the system to alert a user of a forgotten item 100 including the transmitter 101 of FIG. 1A with the USB plug 120 in a second position, according to an exemplary embodiment of the present general inventive concept.

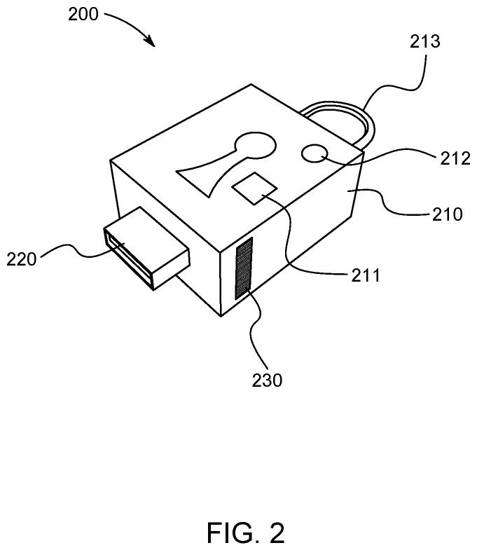

FIG. 2 illustrates a receiver device 200 to connect to the system to alert a user of a forgotten item 100 including the transmitter 101 of FIG. 1A and FIG. 1B, according to an exemplary embodiment of the present general inventive concept.

The system to alert a user of a forgotten item 100 including the transmitter 101, and all components therein and/or connected thereto, including, the receiver device 200, may be constructed from at least one of metal, plastic, wood, silicone, and rubber, etc., but is not limited thereto, and can be constructed from any material known to one of ordinary skill in the art.

Referring to FIGS. 1A and 1B, the system to alert a user of a forgotten item 100 including the transmitter 101 may include a transmitter main body 110, a transmitter universal serial bus (USB) plug 120, a car lighter adapter plug 130, a transmitter speaker 140, and at least one USB port 150.

The transmitter main body 110 may include a USB port holding portion 111, a fulcrum rod 112, a transmitter central processing unit (CPU) 113, a transmitter BLUETOOTH pairing button 114, and a transmitter speaker suppress button 115, but is not limited thereto.

The transmitter CPU 113 may include electronic circuitry to carry out instructions of a computer program by performing basic arithmetic, logical, control and input/output (I/O) operations specified by the instructions. The transmitter CPU 113 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The transmitter CPU 113 may also include a microprocessor and a microcontroller. The transmitter CPU 113 may be a local computer device, a remote server, or cloud computing device.

The transmitter CPU 113 may also include a storage unit, a random access memory (RAM), a read-only memory (ROM), a hard disk, a flash drive, a database connected to the Internet, cloud-based storage, Internet-based storage, or any other type of storage unit.

The transmitter CPU 113 may access the Internet via an internal communication unit to allow the transmitter CPU 113 to access a website, and/or may allow for communication with a mobile application and/or a software application. For ease of description, the mobile and/or the software application will be hereinafter referred to as an app. The app may be downloaded from the Internet to be stored on the storage unit of the transmitter CPU 113.

The communication unit of the transmitter CPU 113 may also allow for BLUETOOTH connectivity (i.e., BLUETOOTH pairing) between the transmitter 101 and a mobile device 10 and/or the receiver device 200. The mobile device 10 may be a cell phone, tablet computer, or any other portable electronic device known to one of ordinary skill in the art.

The transmitter USB plug 120 may be disposed on the USB port holding portion 111. The USB port holding portion 111 may be pivotably connected to the transmitter main body 110 via the fulcrum rod 112, such that the transmitter USB plug 120 may pivotably rotate 90 degrees based on a user's preference.

The transmitter USB plug 120 may be plugged into any USB port to charge an internal battery within the transmitter 101. However, a main purpose of the transmitter USB plug 120 is to plug into a USB port within a vehicle, such that the transmitter 101 is powered on when the vehicle is powered on (i.e., a key is used to power the vehicle).

When the vehicle is powered on by the user and the transmitter USB plug 120 is plugged into the USB port within the vehicle, the transmitter 101 may receive power such that all of the components within the transmitter 101 are activated.

When all of the components within the transmitter 101 are activated, the CPU 113 of the transmitter 101 will recognize any items that are BLUETOOTH paired with the transmitter 101, such as a mobile device 10 and/or any item having the receiver device 200 connected thereto, and if the mobile device 10 and/or any item having the receiver device 200 connected thereto are out of BLUETOOTH connectivity range with respect to the transmitter 101, the transmitter speaker 140 will emit a sound (e.g., bell, chime, etc.) to indicate that the mobile device 10 and/or any item having the receiver device 200 connected thereto is out of BLUETOOTH connectivity range.

Moreover, the user may program the transmitter 101 via the APP running on the mobile device 101, such that the mobile device 10 and/or any item having the receiver device 200 connected thereto are identified. For example, the user can program the transmitter 101 so that the transmitter speaker 140 speaks phrases such as “cell phone” when the mobile device 10 is out of BLUETOOTH connectivity range, “purse” when the receiver device 200 connected to a user's purse is out of BLUETOOTH connectivity range, “laptop” when the receiver device 200 connected to a user's laptop is out of BLUETOOTH connectivity range, etc.

Accordingly, when the user enters the vehicle and powers on the vehicle, the transmitter 101 will either emit a sound or speak the phrases such as “cell phone”, “purse”, “laptop,” etc., to alert the user that the user forgot those items, since those items would be out of BLUETOOTH connectivity range with respect to the transmitter 101. Thus, the user can exit the vehicle to retrieve the forgotten items.

When the forgotten items are located by the user, the user may depress the transmitter speaker suppress button 115 to cause the transmitter speaker 140 to stop emitting sounds and/or stop speaking phrases. (Unplugging the transmitter 101 from the USB port within the vehicle may also cause the transmitter speaker 140 to stop emitting sounds and/or stop speaking phrases.

The car lighter adapter plug 130 may also be included in the transmitter 101 to allow the transmitter 101 to be plugged into a car lighter port in the vehicle, instead of a USB port of the vehicle. It is important to note that the car lighter adapter plug 130 has the same exact functionality as the transmitter USB plug 120, and thus, a repeated description thereof is not further necessary.

Additionally, the mobile device 10 may be programmed via the APP to allow the mobile device 10 to emit a sound, which will help the user to locate the mobile device 10.

The at least one USB port 150 may be provided on the transmitter 101 to allow the user to plug in other USB plugs into the transmitter 101, to compensate for the transmitter 101 taking up valuable USB plug space within the vehicle.

Referring to FIG. 2, the receiver device 200 may include a receiver device main body 210, a receiver device universal serial bus (USB) plug 220, and receiver device speaker 230, but is not limited thereto.

The receiver device main body 210 may include a receiver device central processing unit (CPU) 211, a receiver device BLUETOOTH pairing and speaker suppress button 212, and a receiver device clip 213, but is not limited thereto.

As stated above, the receiver device 200 may be connected to any object using the receiver device clip 213 that is disposed on the receiver device main body 210, including, but not limited to, wallets, purses, laptop computers, bags, briefcases, etc.

The receiver device CPU 211 may include electronic circuitry to carry out instructions of a computer program by performing basic arithmetic, logical, control and input/output (I/O) operations specified by the instructions. The receiver device CPU 211 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The receiver device CPU 211 may also include a microprocessor and a microcontroller. The receiver device CPU 211 may be a local computer device, a remote server, or cloud computing device.

The receiver device CPU 211 may also include a storage unit, a random access memory (RAM), a read-only memory (ROM), a hard disk, a flash drive, a database connected to the Internet, cloud-based storage, Internet-based storage, or any other type of storage unit.

The receiver device CPU 211 may access the Internet via an internal communication unit to allow the transmitter CPU 113 to access a website, and/or may allow for communication with a mobile application and/or a software application. For ease of description, the mobile and/or the software application will be hereinafter referred to as an app. The app may be downloaded from the Internet to be stored on the storage unit of the receiver device CPU 211.

The communication unit of the receiver device CPU 211 may also allow for BLUETOOTH connectivity (i.e., BLUETOOTH pairing) between the receiver device 200 and the transmitter 101.

In detail, the user may when the transmitter 101 and the receiver device 200 are close to each other, the user may depress the transmitter BLUETOOTH pairing button 114 on the transmitter 101 and also depress the receiver device BLUETOOTH pairing and speaker suppress button 212 on the receiver device 200, such that the transmitter 101 is paired with the receiver device 200.

As stated above, when the vehicle is powered on by the user and the transmitter USB plug 120 is plugged into the USB port within the vehicle, the transmitter 101 may receive power such that all of the components within the transmitter 101 are activated.

When all of the components within the transmitter 101 are activated, the CPU 113 of the transmitter 101 will recognize any items that are BLUETOOTH paired with the transmitter 101, such as any item having the receiver device 200 connected thereto that is out of BLUETOOTH connectivity range with respect to the transmitter 101 will cause the transmitter speaker 150 will emit a sound (e.g., bell, chime, speech, etc.) to indicate that the item having the receiver device 200 connected thereto is out of BLUETOOTH connectivity range.

Also, the receiver device speak 230 may emit a sound, which may help the user to locate the item to which the receiver device 200 is attached.

When the item to which the receiver device 200 is attached is located by the user, the user may depress the receiver device BLUETOOTH pairing and speaker suppress button 212 to cause the receiver device 200 to stop emitting the sound.

The receiver device USB plug 220 may be disposed on the receiver device main body 210 and connected to the receiver device CPU 211 to allow an internal battery within the receiver device 200 to be recharged when the receiver device USB plug 220 is plugged into a USB port.

The present general inventive concept may include a transmitter 101 to alert a user of a forgotten item, the transmitter 101 including a transmitter main body 110, a transmitter universal serial bus (USB) plug 120 connected to the transmitter main body 110, such that the transmitter USB plug 120 is insertable into a USB port within a vehicle to provide power to the transmitter 101 when the vehicle is powered on, a transmitter central processing unit (CPU) 113 electrically connected to the transmitter USB plug 120 to allow the transmitter 101 to BLUETOOTH pair with the forgotten item, and a transmitter speaker 140 electrically connected to the transmitter CPU 113 to emit a sound to alert the user when the forgotten item is out of BLUETOOTH connectivity range with respect to the transmitter 101, such that the transmitter speaker 140 emits the sound in response to the vehicle being powered on when the transmitter USB plug 120 is plugged into the USB port within the vehicle and in response to the forgotten item being out of BLUETOOTH connectivity range with respect to the transmitter 101.

The forgotten item may be a mobile device 10.

The transmitter main body 110 may further include a transmitter BLUETOOTH pairing button 114 electrically connected to the transmitter CPU 113 to allow the transmitter 101 to BLUETOOTH pair with the forgotten item in response to the transmitter BLUETOOTH pairing button 114 being pressed when the forgotten item is within a BLUETOOTH connectivity range with respect to the transmitter 101.

The transmitter main body 110 may further include a transmitter speaker suppress button 115 electrically connected to the transmitter CPU to cause the transmitter speaker 140 to stop emitting the sound when the transmitter speaker suppress button 115 is pressed.

The present general inventive concept may also include a system to alert a user of a forgotten item 100, the system including a receiver device 200 having BLUETOOTH connectivity capabilities, the receiver device 200 including a receiver device central processing unit (CPU) 211 to provide the BLUETOOTH connectivity for the receiver device 200, and a transmitter 101, including a transmitter main body 110, a transmitter universal serial bus (USB) plug 120 connected to the transmitter main body 110, such that the transmitter USB plug 120 is insertable into a USB port within a vehicle to provide power to the transmitter 101 when the vehicle is powered on, a transmitter central processing unit (CPU) 113 electrically connected to the transmitter USB plug 120 to allow the transmitter 101 to BLUETOOTH pair with the receiver device 120, and a transmitter speaker 140 electrically connected to the transmitter CPU 113 to emit a sound to alert the user when the receiver device 120 is out of BLUETOOTH connectivity range with respect to the transmitter 101, such that the transmitter speaker 140 emits the sound in response to the vehicle being powered on when the transmitter USB plug 120 is plugged into the USB port within the vehicle and in response to the receiver device 120 being out of BLUETOOTH connectivity range with respect to the transmitter 101.

The receiver device CPU 211 may be programmable to identify the forgotten item, such that the sound emitted by the transmitter speaker 230 identifies the forgotten item by name.

The forgotten item may be one of a purse, a wallet, a laptop, a grocery bag, and a briefcase, and the sound emitted by the transmitter speaker 230 may be one of spoken phrases of “purse,” “wallet”, “laptop”, “grocery bag,” and “briefcase,” respectively.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A transmitter to alert a user of a forgotten item, the transmitter comprising:
a transmitter main body;
a transmitter universal serial bus (USB) plug connected to the transmitter main body, such that the transmitter USB plug is insertable into a USB port within a vehicle to provide power to the transmitter when the vehicle is powered on;
a transmitter central processing unit (CPU) electrically connected to the transmitter USB plug to allow the transmitter to BLUETOOTH pair with the forgotten item; and
a transmitter speaker electrically connected to the transmitter CPU to emit a sound to alert the user when the forgotten item is out of BLUETOOTH connectivity range with respect to the transmitter, such that the transmitter speaker emits the sound in response to the vehicle being powered on when the transmitter USB plug is plugged into the USB port within the vehicle and in response to the forgotten item being out of BLUETOOTH connectivity range with respect to the transmitter.

2. The transmitter of claim 1, wherein the forgotten item is a mobile device.

3. The transmitter of claim 1, wherein the transmitter main body further comprises:
a transmitter BLUETOOTH pairing button electrically connected to the transmitter CPU to allow the transmitter to BLUETOOTH pair with the forgotten item in response to the transmitter BLUETOOTH pairing button being pressed when the forgotten item is within a BLUETOOTH connectivity range with respect to the transmitter.

4. The transmitter of claim 1, wherein the transmitter main body further comprises:
a transmitter speaker suppress button electrically connected to the transmitter CPU to cause the transmitter speaker to stop emitting the sound when the transmitter speaker suppress button is pressed.

5. A system to alert a user of a forgotten item, the system comprising:
a receiver device having BLUETOOTH connectivity capabilities, the receiver device comprising:
receiver device central processing unit (CPU) to provide the BLUETOOTH connectivity for the receiver device; and
a transmitter, comprising;
a transmitter main body,
a transmitter universal serial bus (USB) plug connected to the transmitter main body, such that the transmitter USB plug is insertable into a USB port within a vehicle to provide power to the transmitter when the vehicle is powered on,
a transmitter central processing unit (CPU) electrically connected to the transmitter USB plug to allow the transmitter to BLUETOOTH pair with the receiver device, and
a transmitter speaker electrically connected to the transmitter CPU to emit a sound to alert the user when the receiver device is out of BLUETOOTH connectivity range with respect to the transmitter, such that the transmitter speaker emits the sound in response to the vehicle being powered on when the transmitter USB plug is plugged into the USB port within the vehicle and in response to the receiver device being out of BLUETOOTH connectivity range with respect to the transmitter.

6. The system of claim 5, wherein the receiver device CPU is programmable to identify the forgotten item, such that the sound emitted by the transmitter speaker identifies the forgotten item by name.

7. The system of claim 6, wherein the forgotten item is one of a purse, a wallet, a laptop, a grocery bag, and a briefcase, and the sound emitted by the transmitter speaker is one of spoken phrases of “purse,” “wallet”, “laptop”, “grocery bag,” and “briefcase,” respectively.
